(19) United States
(12) Patent Application Publication
(10) Pub. No.: US 2012/0155811 A1
(43) Pub. Date: Jun. 21, 2012

(54) CONNECTION MODULE OF OPTICAL SIGNALS

(76) Inventors: Nien-Tsu Chiang, Miaoli (TW); Chih-Chiang Hu, Miaoli (TW)

(21) Appl. No.: 13/314,173

(22) Filed: Dec. 7, 2011

(30) Foreign Application Priority Data
Dec. 16, 2010 (TW) 099144281

(51) Int. Cl. G02B 6/36

(52) U.S. Cl. 385/89; 385/92

(57) ABSTRACT

A connection module is provided, including a shell. The shell has formed at least a guiding hole, at least a fiber optical guiding trench on a shell of the module, and a window located inside the shell at the end of fiber optical guiding trench. The guiding hole is located on one side of the shell for fiber optical to enter the shell through the guiding hole. The fiber optical guiding trench is located inside the shell to guide the fiber optical for large angle turns so that the front end of the fiber optical can reach the window. The connection module can be placed on top to cover an optical transceiving area. The optical transceiving area includes at least a point optical source or a receiver so that the optical signals at the optical transceiving area can be transmitted to outside.

### FIELD OF THE INVENTION

The present invention generally relates to a connection module of optical signals, and more specifically to a bi-directional embedded S-Bend technology (BEST).

### BACKGROUND OF THE INVENTION

In comparison with conventional electrical signals, the optical signals have the advantages of big bandwidth, low loss, high security, free of electromagnetic field or radiation interference, and so on, and become the first choice of information communication medium. Fiber optical, because of small signal attenuation, is suitable for long distance communication at a reduced cost. In addition, the fiber optical is light in weight, bendable and easy to form a bundle to save tube space as well as economical for deployment. Hence, as the optoelectronic technology develops and various applications are explored, the fiber optical based communication has not only become the mainstream of the market but also an indicator for modern development.

However, the optical network must include many active optical elements in addition to fiber optical, such as, optical transmitter, optical receiver, optical transceiver, optical amplifier, VCSEL, optical switch, tunable laser, L-Band amplifier and passive optical elements, such as, optical connector, optical coupler, optical attenuator, optical signal modulator, optical polarizer, optical insulator, filter, optical source splitter, optical wave splitter, and so on. Also, because optical network deployment usually requires the elements to be bendable to follow the buildings or the geographical appearance, another important issue of optical network deployment is to ensure the convenience of deployment. The common manners to connect fiber optical include hot melt method, using connector for detachable connection, and so on. The existing deployment methods all require peeling away the material covering fiber core and making the fiber optical into a bundle so that the glass core of the fiber core with high reflectivity can be melted for connection or connected via a connector. This deployment requires extra caution because the fiber core is prone to damage and the optical signal quality can be greatly affected. In addition, the deployment efficiency and quality are also an important factor in optical network deployment.

Take a conventional optical connector as an example. In addition to connecting fiber optical, an optical connector can also be used to connect fiber optical and a light source. A conventional optical connector, such as, VF-45, can be used to connect fiber optical and optical transceiver. The method is to glue VF-45 to the above of the point optical source, and then insert the fiber optical to the lens of guide trench and fasten the fiber optical. Unfortunately, this type of deployment method is not applicable to the automatic fiber insertion machine commonly available in the industry.

FIG. 1 shows a schematic view of a conventional optical source connection module. As shown in FIG. 1, the light transmitted by point optical source 102 soldered to PCB 101 passes reflective lens 103 and enters fiber optical 104 to transmit optical signals. Because not all the light transmitted by point optical source travels along a straight line, for example, the light path of VCSEL is a Gaussian distribution, the light is further scattered the longer the distance of travelling, thus, a weaker light. However, with the conventional connection method, the distance between transmission end 201 of optical source and receiving end 202 cannot be further shortened, as in FIG. 2.

In addition, the conventional construction methods are required to peel away the wrapping layers. The process is not only tedious, but also needs to overcome many problems. For example, when peeling the outer wrap of the fiber optical, the coloring layer on the outside of the fiber optical may crack, loosens or slide, resulting in problems in subsequent fastening of fiber optical. On the other hand, if the coaxial degree between the wrap layer on the outside of fiber optical and the fiber optical itself, the alignment will be problematic after inserting and fastening the fiber optical into the guide trench of a connection module. The conventional design to fasten the fiber optical must take upon precious space on the PCB. Similarly, light-emitting elements, light receiving elements or reflective plates must also be fastened to the PCB, which leading to inefficient use of PCB space.

Many improvements of fiber optical connection module are proposed. For example, WIPO 98/40774 disclosed a fiber optic connector with a fiber bend to an S-shape, applicable to connecting two fiber optics. WIPO 97/23796 disclosed an optical fiber connector using fiber spring force and alignment groove, applicable to connecting two fiber optics or connecting to a fiber optical to an active optical element. However, these improvements are complex in structure and not suitable for automatic insertion machine.

Hence, it is imperative to devise a connection module of for optical source with a simple structure, easy for automatic insertion as well as easy for high efficiency construction deployment.

### SUMMARY OF THE INVENTION

The primary object of the present invention is to provide a connection module of optical signals, able to reduce signal attenuation at the receiving end when applied to light-emitting element for signal transmission, and improve the optical efficiency of optical network.

Another object of the present invention is to provide a connection module of optical signals, allowing direct insertion of a fiber optical into a trench so as to enable automatic manufacturing of optical module.

Yet another object is to provide a connection module of optical signals, able to install directly above a point optical source or a receiver without occupying PCB space.

Another object of the present invention is to provide a connection module of optical signals, with a simple structure to reduce the manufacturing cost.

To achieve the above objects, the present invention provides a connection module having formed at least a guiding hole, at least a fiber optical guiding trench on a shell of the module, and a window located inside the shell at the end of fiber optical guiding trench. The guiding hole is located on one side of the shell for fiber optical to enter the shell through the guiding hole. The fiber optical guiding trench is located inside the shell to guide the fiber optical for large angle turns so that the front end of the fiber optical can reach the window. The connection module can be placed on top to cover an optical transceiving area. The optical transceiving area includes at least a point optical source or a receiver so that the optical signals at the optical transceiving area can be transmitted to outside.

The connection module of optical signals of the present invention can be expanded to connect a plurality of fiber optical to a plurality of point optical sources or a plurality of receivers, and is easy for construction deployment and enables high precision alignment.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a conventional connection module for optical source;

FIG. 2 shows a schematic view of optical signal attenuation when light transmitted by optical source travelling in Gaussian distribution path;

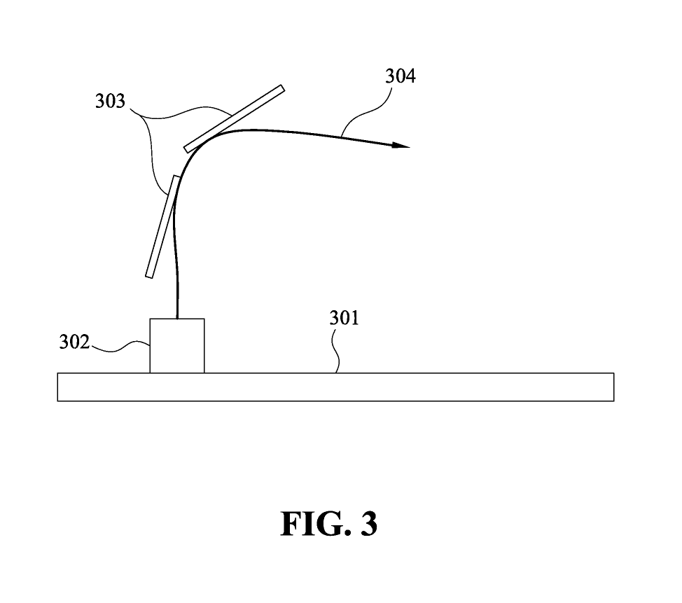

FIG. 3 shows a schematic view of a connection module of optical signals according to the present invention;

FIG. 4A shows a schematic view of an assembled connection module according to the present invention;

FIG. 4B shows a schematic view of a disassembled connection module according to the present invention;

FIG. 5 shows a top view of another embodiment of a connection module of the present invention; and

FIGS. 6A-6C show different embodiments of fiber optical guiding trenches according to the present invention.

### DETAILED DESCRIPTION OF THE PREFERRED EMBODIMENTS

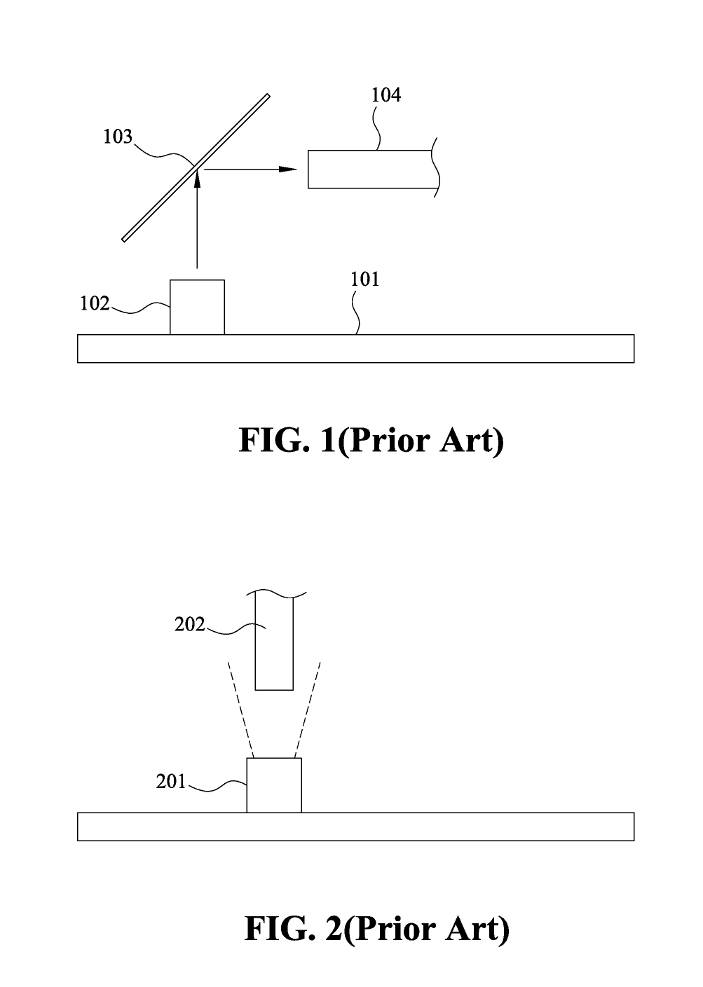

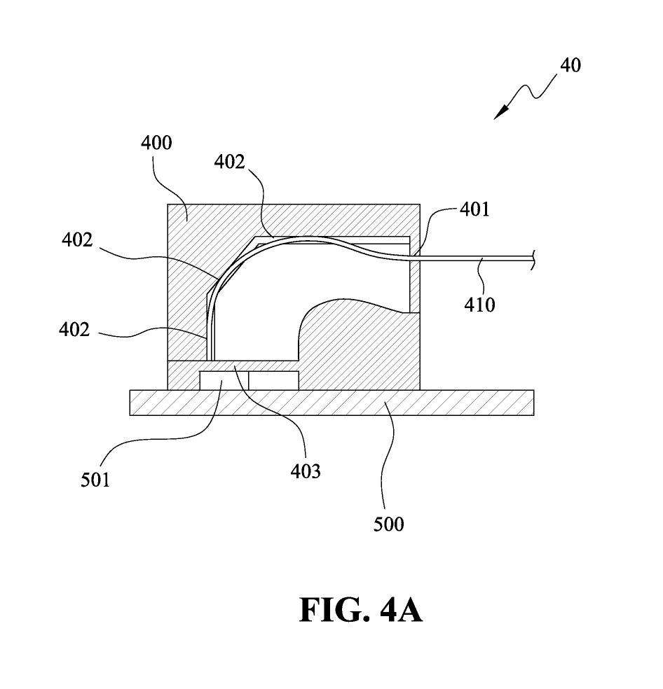

FIG. 3 shows a schematic view of a connection module of optical signals according to the present invention. To reduce the signal attenuation caused by the Gaussian distribution of the light transmission path of an point optical source, the connection module of the present invention uses fiber optical guiding trenches on a set of guiding trench plates 303 to guide fiber optical 304 to an optical transceiving area 302 on a PCB 301. Optical transceiving area 302 includes at least a point optical source or a receiver. For example, fiber optical 304 is guided to direct above of the point optical source with the cutting surface facing the point optical source directly. The dynamic fatigue value ND of fiber optical 304 is preferably greater than 20, with preferred embodiment to be greater than 25. It is worth noting that, in comparison with the design in FIG. 1, the optical path of the present invention is shorter, and is easier for alignment to improve the alignment precision. The alignment in FIG. 1 is done by using reflective plate to reflect the light.

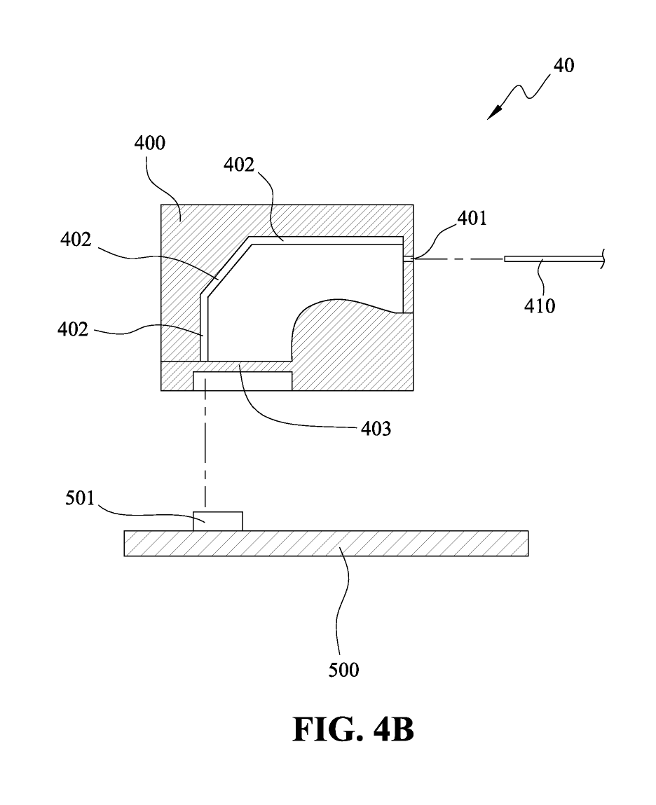

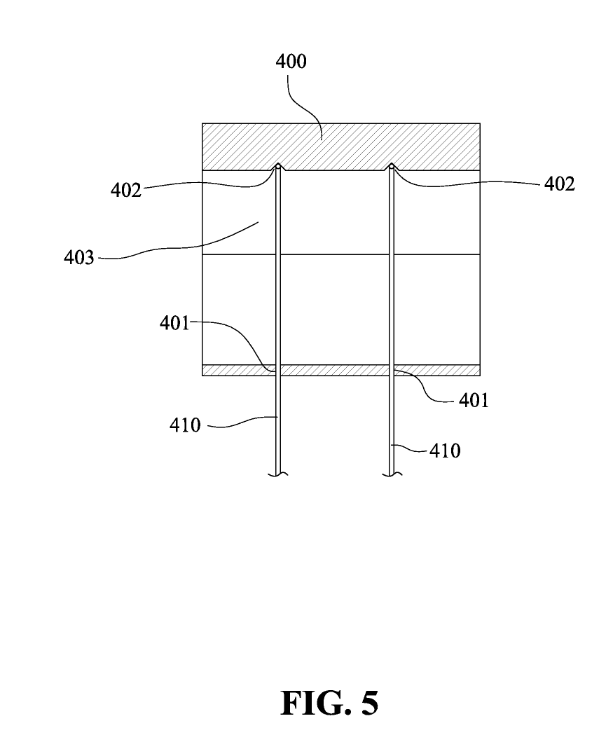

FIGS. 4A and 4B show a schematic assembled view and a disassembled view of the connection module of the present invention, respectively. As shown in FIG. 4A, connection module 40 has a shell 400. Shell 400 includes at least a guiding hole 401, at least a set of fiber optical guiding trenches 402, and a window 403 located at end of fiber optical guiding trenches 402. Shell 400 is a hollow shell to provide space for fiber optical to extend and bend. Guiding hole 401 is located on a side wall of shell 400. The center line of guiding hole 401 is aligned to fiber optical guiding trenches 402. When a fiber optical 410 enters shell 400 through guiding hole 401, fiber optical 410 then also enters corresponding fiber optical guiding trench 402. Fiber optical guiding trenches 402 are a complete set of fiber optical guiding channels formed by the concave trenches on internal walls of shell 400. The end of fiber optical guiding trenches 402 is where window 403 is located. Window 403 is made of a transparent material. Connection module 40 of the present invention is placed to cover an optical transceiving area 501 on a PCB 500. Optical transceiving area 501 includes at least a point optical source or a receiver. In the present embodiment, optical transceiving area 501 includes a point optical source. For convenient assembly, fiber optical 410 has ND>20, and is a single-film fiber optical. That is, only an electroplated layer is on the crystal cord of the fiber optical.

When assembled, connection module 40 is placed to cover the point optical source of optical transceiving area 501, with window 403 aligned to point optical source. Finally, fiber optical 410 enters shell 400 of connection module 40 through guiding hole 401, and follows fiber optical guiding trenches 402 in an winding manner until the front end reaching window 403. At this point, the outside of fiber optical 410 is dotted with glue to fasten to shell 400 to accomplish the assembly of connection module 40.

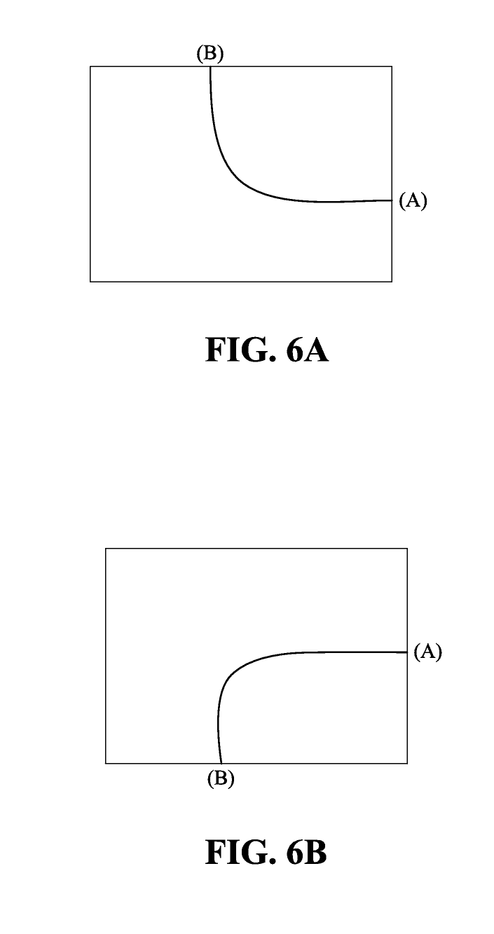

FIG. 5 shows a cross-sectional view of another embodiment of a connection module of the present invention. In this embodiment, connection module 40 includes two sets of fiber optical guiding trenches 402 and two guiding holes 401, applicable to connecting two fiber optical 410 to window 403 respectively. Optical transceiving area 501 can include two point optical sources to match two fiber optical 410, or includes a point optical source and a receiver to match two fiber optical. This embodiment shows that the connection module of optical signals of the present invention can be expanded to connect a plurality of fiber optical to a plurality of point optical sources or a plurality of receivers, and is easy for construction deployment and enables high precision alignment.

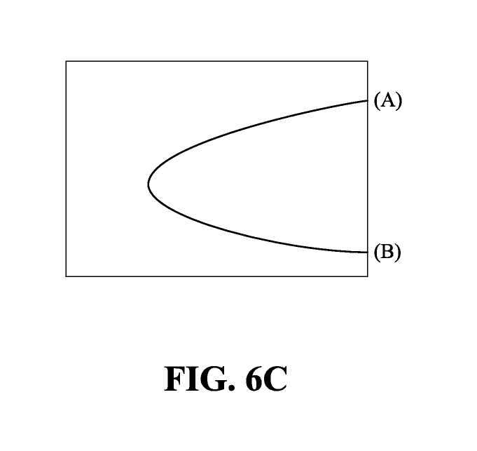

FIG. 6A-FIG. 6C show schematic views of various embodiments of fiber optical guiding trenches according to the present invention. As shown in FIG. 6A-FIG. 6C, the fiber optical guiding trenches of the present invention can be designed to provide different paths to provide more flexibility of aligning fiber optical and optical transceiving area. The (A) in FIG. 6A-6C indicates the location of optical transceiving area, while (B) indicates the entry point of fiber optical. In FIG. 6A, optical transceiving area is located collaterally and the fiber optical extends downwards from above to align. In FIG. 6B, optical transceiving area is located collaterally and the fiber optical extends upwards from below to align. In FIG. 6C, both optical transceiving area and fiber optical are located collaterally, and the fiber optical must turn nearly 180° with a small turning diameter to align. As shown in FIG. 6A-6C, the fiber optical guiding trenches of the present invention can be designed to meet different construction deployment needs. It is also worth nothing that the fiber optical guiding trenches are formed by at least a guiding trench plate inside the shell. The guiding trench plate includes concave trenches. Therefore, the trenches are not necessarily formed on the inner all of the shell.

In comparison with conventional technology, the present invention has the following advantages:
1. The design of fiber optical guiding trenches allows the transmitting end of the optical source or receiving end to be as close to the fiber optical as possible to reduce the signal attenuation.
2. The present invention does not use reflective plate. Instead, the present invention uses fiber optical guiding trenches to guide the cut surface of the fiber optical to contact the window lens. The design of the guiding trench allows insertion and fastening of the fiber optical.
3. The design of fiber optical guiding trenches simplifies the alignment and fastening problem of the fiber optical, and is suitable for mass production.
4. The connection module of the present invention can be directly placed to cover an optical transceiving area on a PCB without taking up extra PCB space so as to reduce manufacturing cost and improve PCB space efficiency.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A connection module of optical signals, applicable to connecting at least a fiber optical to at least an optical transceiving area to form an optical module, said connection module comprising a shell, said shell having at a guiding hole, at least a fiber optical guiding trench and a window;
wherein said guiding located on a side wall of said shell to provide entry point of said fiber optical to enter said shell; said fiber optical guiding trench located inside said shell, and for guiding said fiber optical for large angle turn when said fiber optical entering said shell so that a front end of said fiber optical reaching said window; said window located inside said shell at an end of said fiber optical guiding trench; after assembly, said shell covering said optical transceiving area and said window aligned to an element inside said optical transceiving area.

2. The connection module as claimed in claim 1, wherein said optical transceiving area comprises at least a point optical source or a receiver.

3. The connection module as claimed in claim 1, wherein said fiber optical guiding trench comprises concave trenches on internal walls at different locations inside said shell.

4. The connection module as claimed in claim 1, wherein said fiber optical guiding trench is formed by at least a guiding trench plate inside said shell.

5. The connection module as claimed in claim 1, wherein said fiber optical guiding trench guides said fiber optical to said window so that a front cut surface of said fiber optical contacts directly said window.

6. The connection module as claimed in claim 1, wherein a path formed by said fiber optical guiding trench comprises an obtuse angle.

7. The connection module as claimed in claim 1, wherein a path formed by said fiber optical guiding trench comprises an acute angle.

8. The connection module as claimed in claim 1, wherein said connection module is expanded to application of connecting a plurality of fiber optical.

9. The connection module as claimed in claim 1, wherein said window is right next to said optical transceiving area to increase the signal strength.

10. The connection module as claimed in claim 1, wherein said fiber optical has dynamic fatigue value ND>20.

11. The connection module as claimed in claim 1, wherein said shell of said connection module comprises a plurality of guiding holes, a plurality of fiber optical guiding trenches and a window, front ends of a plurality of fiber optical are guided to the location of said window after assembly.

12. The connection module as claimed in claim 11, wherein when said shell having a plurality of fiber optical covers said optical transceiving area, each fiber optical is aligned through said window to a point optical source or a receiver in said optical transceiving area.

13. The connection module as claimed in claim 12, wherein when said shell having a plurality of fiber optical covers said optical transceiving area, the number of point optical sources in said optical transceiving area is the same as the number of receivers.
